(19) United States
(12) Patent Application Publication
(10) Pub. No.: US 2008/0161016 A1
(43) Pub. Date: Jul. 3, 2008

(54) SYNTHETIC APERTURE FOR LOCATING MOBILE TRANSMITTERS

(75) Inventors: Bertrand M. Hochwald, Summit, NJ (US); Thomas L. Marzetta, Summit, NJ (US); Dennis M. Romain, Morristown, NJ (US)

Correspondence Address: HITT GAINES, PC;ALCATEL-LUCENT, PO BOX 832570, RICHARDSON, TX, 75083, US

(73) Assignee: Lucent Technologies Inc., Murray Hill, NJ (US)

(21) Appl. No.: 11/617,643

(22) Filed: Dec. 28, 2006

(51) Int. Cl. H04Q 7/20

(52) U.S. Cl. 455/456.2

(57) ABSTRACT

The present invention provides a module for locating a mobile device. In one embodiment, the module is configured to determine a location of a mobile device based on phase-sensitive measurements of wireless signals transmitted by the mobile device. Correspondingly, the module is configured to determine the location based on the phase-sensitive measurements of the wireless signals made at multiple measurement sites.

### U.S. GOVERNMENT

The U.S. Government has a paid-up license in this invention and the right, in limited circumstances, to require the patent owner to license others on reasonable terms as provided for by the terms of Contract No. 2004-A123560-000.

### TECHNICAL FIELD OF THE INVENTION

The present invention is directed, in general, to wireless signal processing and, more specifically, to a system and method for locating a mobile transmitter such as a cellular phone.

### BACKGROUND OF THE INVENTION

It has become increasingly important to be able to locate the position of a mobile transmitter, such as a cellular phone, in a variety of situations. Cell phone service providers are capable of providing such information through satellite tracking. However, obtaining such tracking information is usually difficult and often only available through a court order. This is both time consuming and may not be a reasonable course of action if the cellular phone is operating in a foreign country or the time constraints of the situation are limiting.

Using an aircraft located above the cellular phone to receive signals from the cellular phone could provide a way to determine its location. For example, using a receiving antenna array of one to two meters length would give an angular resolution of approximately λ/L_{AA}=(0.33 meters)/(2 meters)=0.17 radians, where λ is the wavelength for a 900 MHz wireless signal associated with the cellular phone and L_{AA} is the length of the antenna array. At a distance of 20,000 meters from the cellular phone, this angular resolution translates to a spatial resolution of (20,000 meters)*0.17 radians=3,400 meters, which is too large for many purposes. A spatial resolution improvement by a factor of at least 100 would normally be required. This improvement is large, especially if the distance of the aircraft from the mobile transmitter cannot be appropriately reduced.

Additionally, the desired tracking signal generally will be corrupted by many interfering signals that arrive from many different directions. When the number of interferers is comparable to the number of array elements in a receiving antenna, adaptive processing techniques that are based on second-order statistics are not likely to yield great improvements in the ability to discern a desired signal. This is due to the interference being nearly spatially white. Alternatively, the use of higher-order statistics (for example, exploiting the fact that QPSK signals have constant modulus) could yield improvements over methods based on second-order statistics. However, a sufficiently large number of interferers will look Gaussian (via the central limit theorem) thereby rendering higher order statistics of little or no benefit.

Accordingly, what is needed in the art is an enhanced way to determine the location of a mobile transmitter employing an aircraft.

### SUMMARY OF THE INVENTION

To address the above-discussed deficiencies of the prior art, the present invention provides a module for locating a mobile device. In one embodiment, the module is configured to determine a location of a mobile device based on phase-sensitive measurements of wireless signals transmitted by the mobile device. Correspondingly, the module is configured to determine the location based on the phase-sensitive measurements of the wireless signals made at multiple measurement sites.

In another aspect, the present invention provides a method of locating a mobile transmitter. The method includes receiving a wireless signal from a mobile transmitter at a sequence of locations of a receiver. The method also includes determining one or more phase-dependent characteristics of the wireless signal, wherein the one or more characteristics depend on relative locations of the receiver and the mobile transmitter. The method further includes finding a geo-location of the mobile transmitter from the determined one or more phase-dependent characteristics.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a diagram of an embodiment of a system for locating a mobile transmitter constructed in accordance with the principles of the present invention;

FIG. 2 illustrates a plan view for the embodiment of the system of FIG. 1 showing a synthetic aperture geo-location (SAG) technique constructed in accordance with the principles of the present invention;

FIGS. 3A and 3B respectively illustrate a measurement arc diagram and a corresponding SAG diagram constructed in accordance with the principles of the present invention;

FIGS. 4A and 4B respectively illustrate an alternative measurement arc diagram and a corresponding SAG diagram constructed in accordance with the principles of the present invention;

FIGS. 5A and 5B respectively illustrate another alternative measurement arc diagram and a corresponding SAG diagram constructed in accordance with the principles of the present invention;

FIG. 6A illustrates a measurement arc diagram of an embodiment of measurement arcs constructed in accordance with the principles of the present invention;

FIG. 6B illustrates a diagram of uncompensated LOPs corresponding to the synthetic aperture measurements on the MOI of FIG. 6A;

FIG. 6C illustrates a diagram of calculated LOVs corresponding to the synthetic aperture measurements on the moving MOI of FIG. 6A;

FIG. 6D illustrates a diagram of compensated LOPs corresponding to the synthetic aperture measurements on the moving MOI of FIG. 6A; and

FIG. 7 illustrates a flow diagram of an embodiment of a method for locating a mobile transmitter carried out in accordance with the principles of the present invention.

### DETAILED DESCRIPTION

Referring initially to FIG. 1, illustrated is a diagram of an embodiment of a system for locating a mobile device employing a transmitter, generally designated 100, constructed in accordance with the principles of the present invention. The system 100 includes the mobile device in the form of a cell-phone 105 coupled to a base station 110 and an aircraft 115, which is an airplane in this embodiment, that is orbiting the cell-phone 105. The cell phone 105 is within the coverage radius of the base station 110 and the base station antenna serves as a coordinate-axis origin corresponding to a reference geo-location, as shown.

The system 100 also includes a detection module 120 that is co-located with the aircraft 115. The detection module 120 includes a directional antenna array 121 coupled to a received signal processor 122 that is also coupled to a position interface 123. The directional antenna array 121 provides a data signal proportional to the wireless signals transmitted by the cell phone 105 and the base station 110. The directional antenna array 121 employs vertical and radial antenna elements or tangential and transverse antenna elements with respect to an orbit defined by the aircraft 115. Additionally, these antenna elements are generally configured to employ half-wavelength spacing for the received wireless signals of interest.

The received signal processor 122 is configured to determine a mobile geo-location of the cell phone 105 relative to the base station 110 based on measurements of wireless signals transmitted by the cell phone 105 and the base station 110. The received signal processor 122 determines the mobile geo-location of the cell phone 105 employing phase-sensitive measurements of the wireless signals made at different positions of the aircraft 115 that provide multiple measurement sites for the detection module 120.

The received signal processor 122 employs a synthetic aperture geo-location technique (further discussed below) that uses multiple receptions of the wireless signals to reduce an error in a corresponding geo-location of the cell phone 105 below a predetermined value. In one embodiment, these receptions occur at regularly-spaced measurement positions.

The position interface 123 provides position data corresponding to the multiple measurement sites. In one embodiment, the position data corresponds to the detection module 120 moving in a substantially circular trajectory around the cell phone 105. Additionally, the position data may correspond to the detection module 120 maintaining a substantially constant altitude or speed, as well.

The cell-phone 105 is at some unknown position represented by mobile geo-location coordinates (xₒ,yₒ,0) relative to the base station 110. Correspondingly, the airplane 115 is flying overhead and located at airplane coordinates (xₚ,yₚ,zₚ) in this coordinate system. The airplane 115 has a velocity v and an antenna array located inside the airplane 115 with its axis aligned with the velocity v. An angle-pair (φ,θ) locate emissions from the cell-phone 105 with respect to the direction of the velocity v of the airplane 115, as shown.

At the uplink frequency of the cell-phone 105, the antenna array of the aircraft 115 measures a combination of the desired signal and the signal from interfering cells is shown in equation (1) below.

$${\underline{x}}_{t} = {\underline{o}}_{t} + {\sum }_{𝓁 = 1}^{L} {\underline{o}}_{t}^{( 𝓁 )} + {\underline{w}}_{t} , \qquad ( 1 )$$

where oₜ represents the desired signal, the L terms in the summand represent interference, and there is additive noise wₜ. The L terms are not necessarily known.

FIG. 1 indicates the geometry associated with the base station 110, cell-phone 105 and airplane 115. The model for the desired cell-phone signal as seen by the aircraft antenna array is shown in equation (2) below.

$${\underline{o}}_{t} = b \cdot {s}_{t} \underline{a} ( φ , θ ) {e}^{\frac{{iω}_{0} ‖ {\underline{r}}_{t} ‖}{c}} , \qquad ( 2 )$$

where b is a complex number denoting the amplitude and phase of the received signal, sₜ is a discrete message-bearing signal, α(φ,θ) is a steering vector response to a signal arriving with the angle pair (φ,θ), ω₀ is a cellular signal carrier frequency and c is the speed of light. The angles φ and θ are measured as azimuth and elevation as shown in FIG. 1.

The angles φ and θ are given by equation (2a) below.

$$φ = {cos}^{- 1} [ \frac{\underline{v} \cdot ( {x}_{o} , {y}_{o} )}{‖ \underline{v} ‖ ‖ ( {x}_{o} , {y}_{o} ) ‖} ] \\ θ = {cos}^{- 1} [ \frac{{z}_{p}}{\sqrt{{( {x}_{p} - {x}_{o} )}^{2} + {( {y}_{p} - {y}_{o} )}^{2} + {z}_{p}^{2}}} ] \qquad ( 2 a )$$

and represent the desired location of the cell-phone 105 with respect to the velocity vector v of the airplane 115.

Inter-array processing can improve angular position estimation accuracy by providing a longer baseline for coherent measurements. As noted previously, a small antenna array of one to two meters in extent, gives a cross-range resolution of 3,400 meters at 900 MHz and a range of 20,000 meters. One way to improve the resolution is to use synthetic aperture techniques to create, in effect, a considerably longer antenna array. For example, the aircraft 115 may fly in a circular trajectory and combine coherently the cell-phone's signal over segments of the trajectory.

Assume for the moment, that the aircraft 115 is flying on a substantially constant-velocity trajectory, and that it has a single receive antenna located at the center of the antenna array. A received signal oₜ may be modeled at M equally-spaced locations as shown by equation (3) below.

oₜ=b·sₜe^{ikΔt}+wₜ,t=1, . . . M (3)

where Δ is the spacing between the measurement points (measured in meters), k is the wavenumber of the desired signal along the trajectory (measured in radians/meter, and equal to (ω₀/c)sinθ) and ωₜ is uncorrelated complex Gaussian noise with variance N₀. It is assumed that the message-bearing signal sₜ is known (either because it is a pilot, or because the message has been decoded). The wavenumber k and the complex constant b are unknown.

The Cramer-Rao bound for estimating the wavenumber k is given by equation (4) below (where it is assumed that sₘ has a constant modulus).

$${σ}_{k} \geq \sqrt{\frac{6}{M {ρΔ}^{2} ( {M}^{2} - 1 )}} , \\ {σ}_{k} \approx \sqrt{\frac{6}{M ρ {W}^{2}}} \qquad ( 4 )$$

where ρ is the signal-to-interference+noise ratio (SINR), shown in equation (5) below:

$$ρ = \frac{{\vert b \vert}^{2} {\vert s \vert}^{2}}{{N}_{0}} , \qquad ( 5 )$$

and W=MΔ is the length of the synthetic aperture. For a fixed aperture W the standard deviation is inversely proportional to the square-root of the number of measurements M that are coherently integrated. In contrast, for a fixed number of measurements, the standard deviation is inversely proportional to the length of the synthetic aperture.

For simplicity, assume that the emitter (the cell-phone 105) is directly under the mid-point of the synthetic aperture. Then the Cramer-Rao bound for estimating the emitter's position along the axis of the synthetic aperture is shown in equation (6) below.

$${σ}_{x} \geq \frac{{z}_{p} c}{{ω}_{0}} \sqrt{\frac{6}{M ρ {Δ}^{2} ( {M}^{2} - 1 )}} . \qquad ( 6 )$$

Suppose that a position accuracy of σₓ equal to 30 meters is desired for an aircraft altitude of zₚ meters and at a carrier frequency of ω₀=2π(9×10⁸). Assume a spacing of one-half wavelength Δ=πc/ω₀=1/6 meters, and a SINR of 0.0 dB (ρ=1.0). Then, equation (6) may be solved to obtain the required number of measurements to combine coherently. This result provides M=65, which is equivalent to a synthetic aperture length of W=65/6, which is about 10 meters.

A straight-line synthetic aperture only provides a one-dimensional angle measurement. However, by flying the aircraft 115 in a circular trajectory, for example, complete geo-location information may be obtained. An aircraft moving at 100 meters/second could traverse a circle having a 1000 meter radius in 60 seconds producing only about one “g” of centripetal acceleration. Therefore, a new synthetic aperture geo-location (SAG) algorithm will be considered where a receiving platform (such as the aircraft 115) is in a substantially constant-speed circular trajectory at substantially constant altitude.

A directional antenna is pointed sideways (radially toward the center of the trajectory) and downward into the cell being served by the base station 105 that is being circled. It is assumed that a signature (either pilot or decoded message-bearing symbols) of the cell-phone 115 (i.e., the mobile of interest (MOI)) is known. Then the received signal from the MOI, when correlated with the signature, has a progressive phase shift due to the changing range between the platform and the MOI. As a function of continuous time t, the received signal is given by equation (7) below.

oₜ=b·sₜe^{-i2πr(t)/π}+wₜ, (7)

where, as before, sₜ is the signature of the MOI that is assumed known, r(t) is the instantaneous range between the MOI and the receiving antenna on the platform, λ=2πc/ω₀ is the wavelength, and b is an unknown complex scalar.

An initial approach is to perform coherent integration over a restricted internal of time such that the progressive phase shift is linear. The quadratic higher-order phase-terms are being ignored and it is assumed that the planes trajectory is piecewise-linear. The range r(t) is expanded in a Taylor series about time t=t₀, where t₀ is the time at which the platform is at the mid-point of the synthetic aperture. In general, for any platform or target motion the range is shown in equation (8) below.

r(t)=∥r(t), (8)

where r(t) is the vector difference of the Cartesian positions of the platform and the MOI as shown in FIG. 1.

Then,

r(t)=xₚ(t)−xₒ(t), (9)

where xₚ(t) and xₒ(t) are the positions of the platform and the MOI respectively. Using this notation, the following expansion shown in equation (10) may be accomplished:

$$r ( t ) = r + \frac{{\underline{r}}^{T} \dot{\underline{r}}}{r} \cdot ( t - {t}_{0} ) + [ - \frac{{( {\underline{r}}^{T} \underline{\dot{r}} )}^{2}}{{r}^{3}} + \frac{{\underline{\dot{r}}}^{T} \underline{\dot{r}} + {\underline{\dot{r}}}^{T} \underline{\ddot{r}}}{r} ] \cdot \frac{{( t - {t}_{0} )}^{2}}{2} + … , \qquad ( 10 )$$

where, in the coefficients of the Taylor series, r(t) and r(t) and its derivatives are evaluated at t=t₀.

Now, assume a circular constant-speed trajectory for the platform and a stationary MOI as shown in equation (11) below.

$${\underline{x}}_{p} ( t ) = [ \begin{matrix}{r}_{p} cos ( {α}_{p} t ) \\ {r}_{p} sin ( {α}_{p} t ) \\ {z}_{p}\end{matrix} ] , \\ {\underline{x}}_{o} ( t ) = [ \begin{matrix}{x}_{o} \\ {y}_{o} \\ 0\end{matrix} ] , \qquad ( 11 )$$

where rₚ is the radius of the platform's circular trajectory and αₚ is the angular speed of the platform in radians/second. The substitution of equation (11) into equations (8), (9) and (10) gives equation (12) below.

$$\begin{matrix}r ( t ) = r + \frac{{α}_{p} {r}_{p}}{r} \cdot [ {x}_{o} sin ( {α}_{p} {t}_{0} ) - {y}_{o} cos ( {α}_{p} {t}_{0} ) ] ( t - {t}_{0} ) + \frac{{α}^{2} {r}_{p}}{r} \cdot [ ( {x}_{o} cos ( {α}_{p} {t}_{0} ) + {y}_{o} sin ( {α}_{p} {t}_{0} ) ) - \frac{{r}_{p}}{{r}^{2}} {( {x}_{0} sin ( {α}_{p} {t}_{0} ) - {y}_{o} cos ( {α}_{p} {t}_{0} ) )}^{2} ] \frac{{( t - {t}_{0} )}^{2}}{2} + … , \\ where & ( 12 ) \\ r = {[ {r}_{p}^{2} + {z}_{p}^{2} + {x}_{o}^{2} + {y}_{o}^{2} - 2 {r}_{p} ( {x}_{o} cos ( {α}_{p} {t}_{0} ) + {y}_{o} sin ( {α}_{p} {t}_{0} ) ) ]}^{1 / 2} \approx {z}_{p} . & ( 13 )\end{matrix}$$

Now, perform coherent integration over an interval of duration T seconds, tε[t₀−T/2,t₀+T/2], and make T as large as possible consistent with the quadratic and higher-order terms remaining negligible. Taylor's theorem with remainder provides an upper bound on the error. Require that the error be less than one-quarter wavelength, which translates into the requirement shown in equation (13a) below.

$$\frac{{α}_{p}^{2} {T}^{2} {r}_{p} \sqrt{{x}_{o}^{2} + {y}_{o}^{2}}}{8 r} \leq \frac{λ}{4} , \qquad ( 13 a )$$

or, alternatively, in terms of the arc-length of the synthetic aperture W as shown in equation (14) below.

$$W = {α}_{p} {r}_{p} T \leq {[ \frac{2 λ {rr}_{p}}{\sqrt{{x}_{o}^{2} + {y}_{o}^{2}}} ]}^{1 / 2} . \qquad ( 14 )$$

Assume, for example, that λ=1/3 meters, rₚ=1,000 meters, zₚ=2×10⁴ meters and \sqrt{xₒ²+yₒ²}≦rₚ. Then, a synthetic aperture may be utilized such that W≦115.5 meters.

In summary, if the synthetic aperture is restricted according to equation (14), then a first-order Taylor series is very accurate, and the signal model of equation (7) takes the simple form:

$${o}_{t} \approx b \cdot {s}_{t} exp \{ - \frac{\begin{matrix}i 2 π {α}_{p} {r}_{p} \cdot [ {x}_{o} sin ( {α}_{p} {t}_{0} ) - \\ {y}_{o} cos ( {α}_{p} {t}_{0} ) ] ( t - {t}_{0} )\end{matrix}}{λ r} \} + {w}_{t} , \qquad ( 15 )$$

where the phase shift exp{12πr/λ} has been absorbed in the scalar b. It may be noted that this signal model is exactly the form of equation (3), wherein the sole difference is that the synthetic aperture is indexed by time rather than by space. The parameters in the two models may be identified as follows:

$${α}_{p} {r}_{p} T = M Δ , \frac{2 π [ {x}_{o} sin ( {α}_{p} {t}_{0} ) - {y}_{o} cos ( {α}_{p} {t}_{0} ) ]}{λ r} = k \qquad ( 16 )$$

Again, the data is processed over the synthetic aperture by taking an FFT and finding the wavenumber k having the peak magnitude.

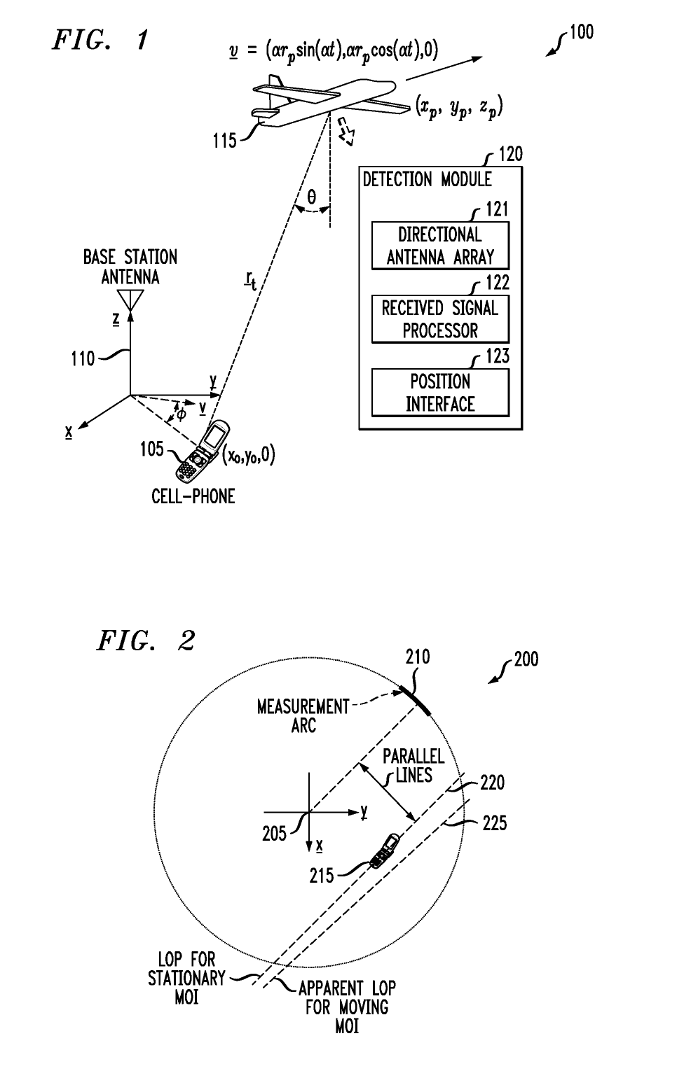

Turning now to FIG. 2, illustrated is a plan view, generally designated 200, for the embodiment of the system 100 of FIG. 1 showing a synthetic aperture geo-location (SAG) technique constructed in accordance with the principles of the present invention. The plan view 200 may be referred to as SAG view 200 wherein the SAG is performed by an airplane traveling in a substantially circular trajectory around a base station 205 located at the origin of the coordinates shown. A SAG measurement arc 210 (an arc of the synthetic aperture shown highlighted) corresponds to a portion of the circular trajectory over which a SAG measurement occurs. The dashed line through a MOI 215 represents a stationary line-of-position (LOP) 220 corresponding to the ambiguity of a noise-free measurement for the location of the MOI 215, which is stationary. A moving LOP 225 represents the additional ambiguity introduced by the MOI 215, when moving.

A single SAG measurement does not give a unique estimate for the position of the MOI 215. Rather, it indicates, in the absence of noise, that the MOI 215 lies on an LOP defined by:

$${x}_{o} sin ( {α}_{p} {t}_{0} ) - {y}_{o} cos ( {α}_{p} {t}_{0} ) = \frac{k λ r}{2 π} \qquad ( 17 )$$

The SAG measurement provides the distance between the MOI 215 and a line that bisects the SAG measurement arc 210, as shown in FIG. 2. Two independent SAG measurements would provide two LOPs, whose intersection would yield a unique estimate for the position of the MOI 215.

The Cramer-Rao analysis of equation (5) gives a lower bound on the standard deviation of the position of the stationary LOP 220, as shown below.

$$\begin{matrix}σ \geq \frac{λ r}{2 π} \sqrt{\frac{6}{M ρ {Δ}^{2} ( {M}^{2} - 1 )}} \\ \approx \frac{λ r}{2 π W} \sqrt{\frac{6}{M ρ}}\end{matrix} \qquad ( 18 )$$

By restricting the size of the synthetic aperture, several real benefits may be obtained. First, the SAG processing is particularly simple (i.e., an FFT). Second, if the MOI 215 happens to be moving, the same processing may be used with a possible further restriction on the length of the synthetic aperture.

The first-order term in the Taylor expansion of r(t) in equation (10) is proportional to the relative velocity between the platform and the MOI 215 projected onto the line that joins the platform and the MOI 215. If the MOI 215 is stationary, then the relative velocity lies along the arc of the synthetic aperture, and the SAG measurement is proportional to the cross-range between the MOI 215 and the line that bisects the arc 210.

Computer-generated data were used to simulate a SAG algorithm as described above. The simulation uses the geometry and scenario developed in FIGS. 1 and 2 and assumes no noise interference. In performing the coherent integration for a two-dimensional SAG, one can integrate over an arbitrarily long arc such that the progressive phase depends nontrivially on both coordinates of an MOI and is a nonlinear function of time, provided one takes this into account in the processing.

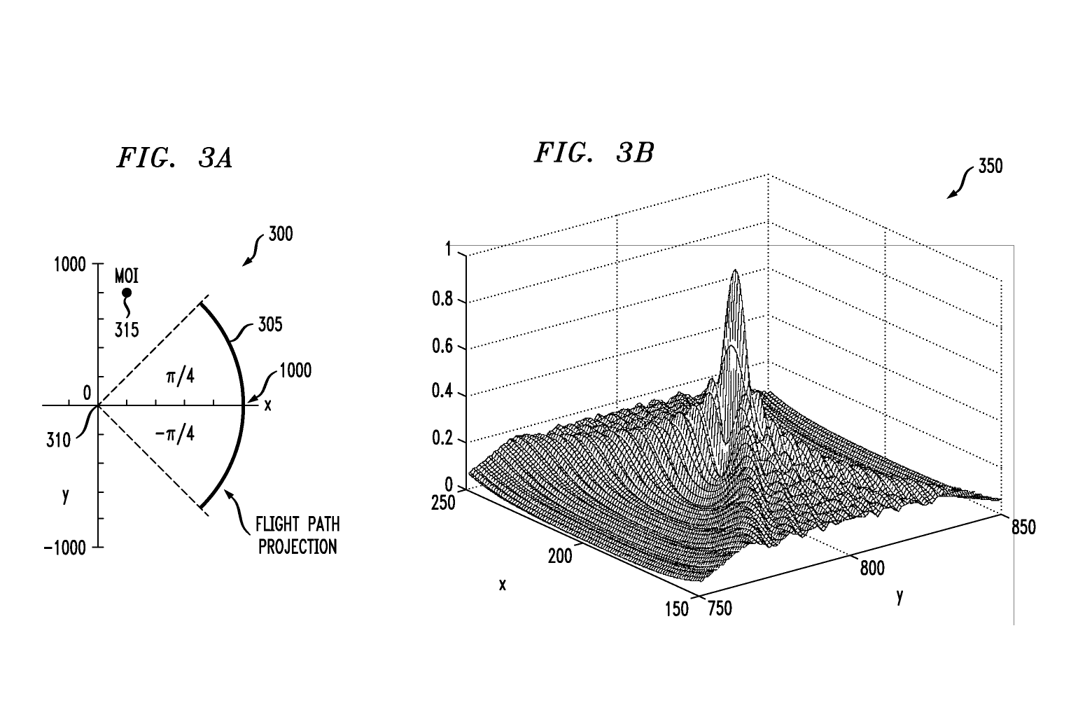

The following simulations illustrate both the advantages and the disadvantages of this type of processing. In the simulation, an MOI was placed at (x-y) coordinates (200,800) meters, and synthetic noise-free SAG data was generated corresponding to a platform circular trajectory of radius 1000 meters, three angular measurement arcs consisting of [−π/4,π/4], [−π/8,π/8], [−π/16,π/16] and a platform altitude of 20,000 meters. The simulation used a UMTS mobile transmitter cellular phone (carrier frequency of 1.8642 GHz). The SAG processing consists of coherently integrating the complex-valued received signal, after de-spreading and correlation with the conjugate of the modulating signal, and removing the progressive phase that would result from an assumed position of the MOI. This procedure is repeated for a multiplicity of assumed MOI coordinates. The peak absolute value of the integrated signal yields the estimate for the two coordinates of the MOI. These simulation results are discussed in FIGS. 3, 4 and 5, which follow.

Turning now to FIGS. 3A and 3B, respectively illustrated are a measurement arc diagram, generally designated 300, and a corresponding SAG diagram, generally designated 350, constructed in accordance with the principles of the present invention. The measurement arc diagram 300 includes a SAG measurement arc 305, which is a portion of a substantially circular trajectory traced out by an orbiting aircraft. The measurement arc diagram 300 also includes a coordinate system wherein the origin corresponds to the location of a base station 310 and an MOI 315 having mobile geo-location coordinates (xₒ,yₒ) of 200 and 800 meters with respect to the base station 310.

The SAG diagram 350 includes a processed two-dimensional SAG (involving a full search) with integration over the SAG measurement arc 305 of [−π/4,π/4] radians, as shown. A peak of the processed two-dimensional SAG is located at the true coordinates of the MOI, which are (xₒ,yₒ)=(200,800). The SAG diagram 350 is a plot of the absolute value of the coherently-integrated signal as a function of the assumed x-y coordinates (plus and minus fifty meters about the true location). As expected, the peak value of the integrated signal is located at the true coordinates of the MOI 315. It should be note that the peak is much sharper in the y-direction than in the x-direction (mesh points are spaced one meter apart). Note also the presence of side lobes in the diagonal directions.

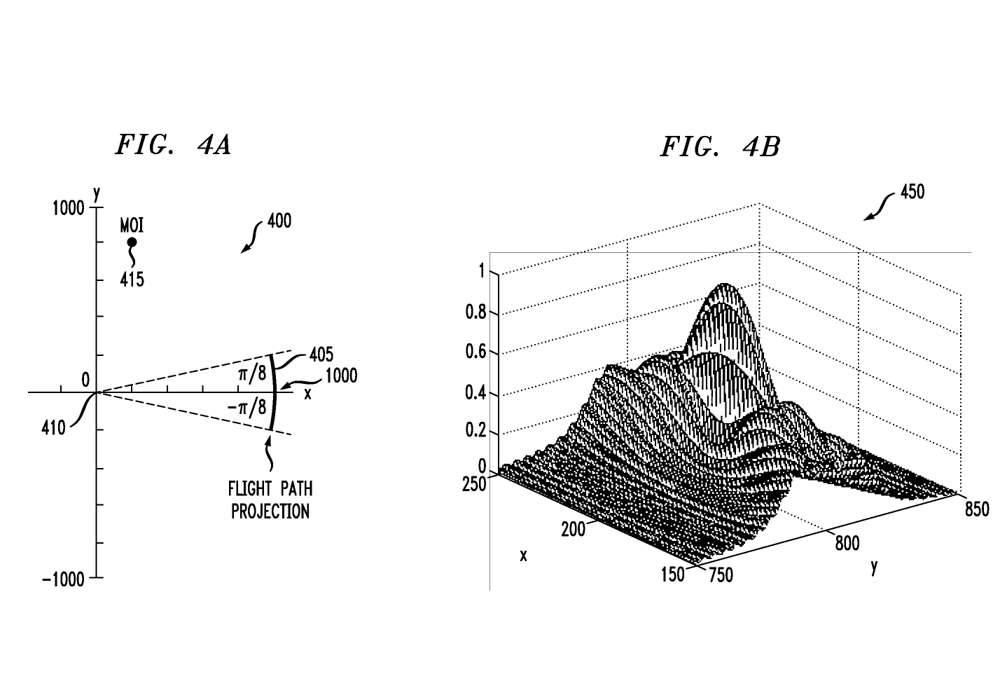

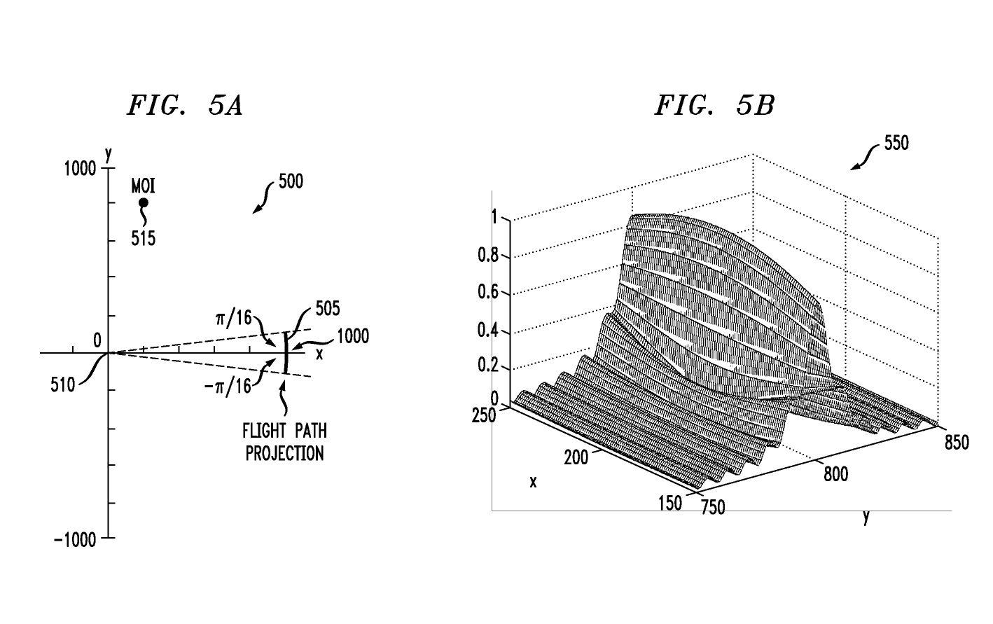

Turning now to FIGS. 4A and 4B, respectively illustrated are an alternative measurement arc diagram, generally designated 400, and a corresponding SAG diagram, generally designated 450, constructed in accordance with the principles of the present invention. The measurement arc diagram 400 includes a SAG measurement arc 405, which is a portion of a substantially circular trajectory path flown by an orbiting aircraft. The measurement arc diagram 400 also includes a similar coordinate system, for comparison purposes, having an origin corresponding to the location of a base station 410 and an MOI 415 also having respective mobile geo-location coordinates (xₒ,yₒ)=(200,800), as shown.

The SAG diagram 450 includes a processed two-dimensional SAG corresponding to the SAG measurement arc 405 being integrated over a measurement arc of [−π/8,π/8] radians, as shown. The peak of the diagram is located at the true coordinates of the MOI of (x,y)=(200,800) as before, but the resolution along the x-axis is seen to be materially worse than the SAG diagram 350.

Turning now to FIGS. 5A and 5B, respectively illustrated are another alternative measurement arc diagram, generally designated 500, and a corresponding SAG diagram, generally designated 550, constructed in accordance with the principles of the present invention. The measurement arc diagram 500 includes a SAG measurement arc 505, which also includes a similar coordinate system, for comparison purposes, having an origin corresponding to the location of a base station 510 and an MOI 515 also having respective mobile geo-location coordinates (xₒ,yₒ)=(200,800), as shown.

The SAG diagram 550 includes a processed two-dimensional SAG corresponding to the SAG measurement arc 505 being integrated over an arc of [−π/16,π/16] radians, as shown. The peak of the diagram is again located at the true coordinates for the MOI 515 of (x,y)=(200,800), as before. For this case, the peak is nearly flat along the x-direction and the SAG processing has effectively yielded a LOP for the MOI 515 given by the equation (yₒ=800).

FIGS. 3, 4 and 5 demonstrate that when the coherent integration arc is long enough the two-dimensional SAG processing yields the two coordinates of the MOI (rather than merely an LOP). However, the processing is highly intensive, and motion of the MOI would require a four-parameter search. For these reasons, the use of short integration intervals is preferred such that the progressive phase is linear with respect to time.

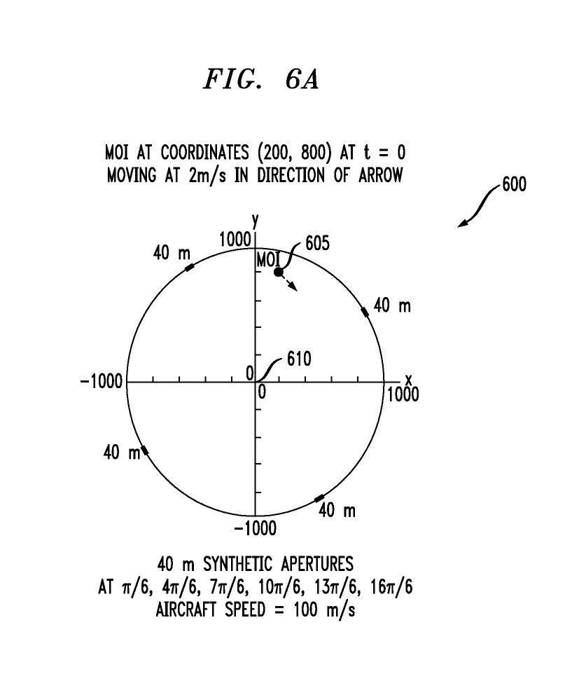

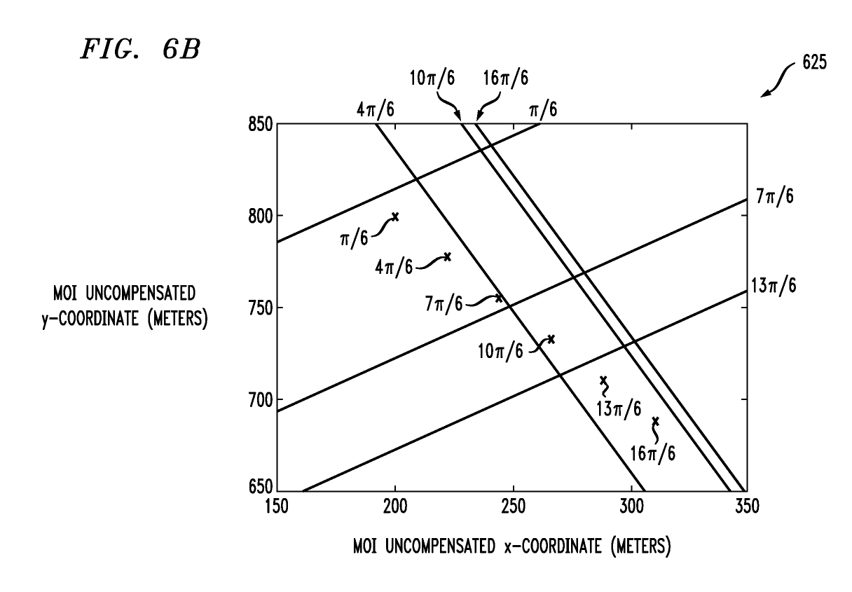

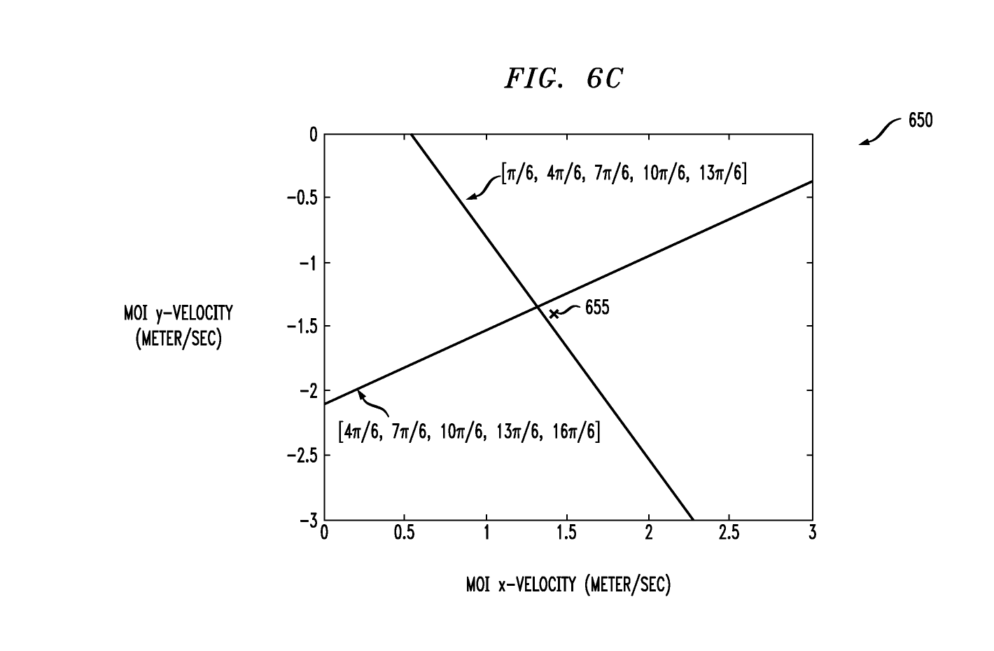

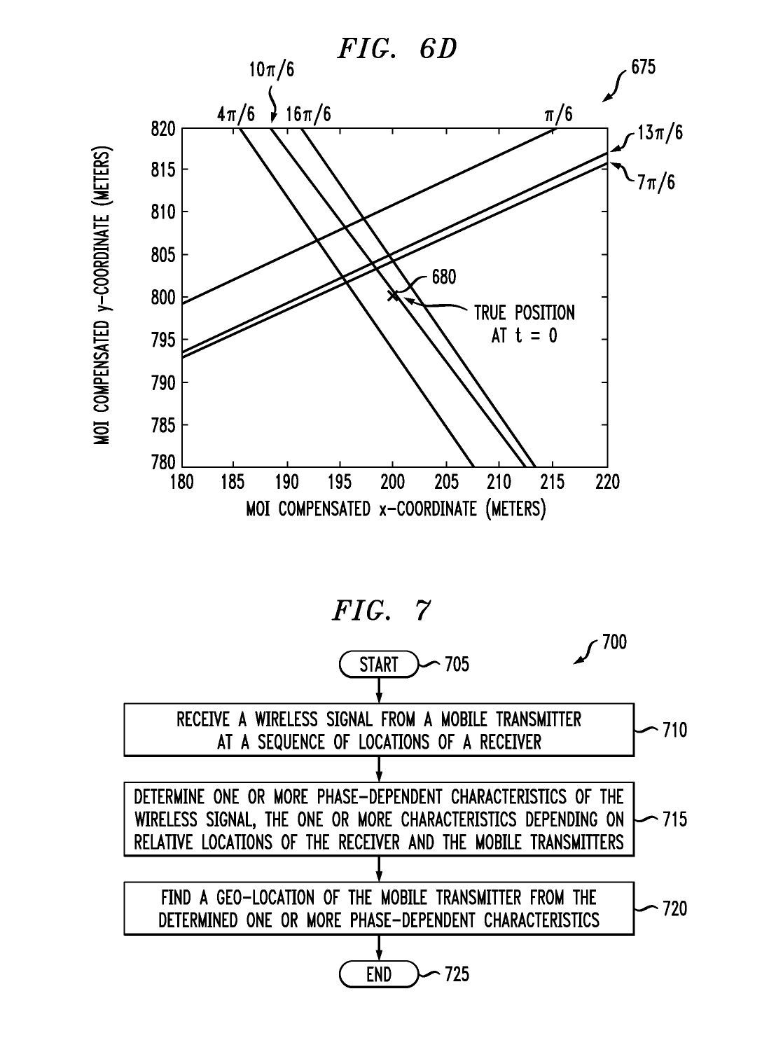

Turning now to FIG. 6A, illustrated is a measurement arc diagram of an embodiment of measurement arcs, generally designated 600, constructed in accordance with the principles of the present invention. The measurement arc diagram 600 includes an MOI 605 initially located at mobile geo-location coordinates (xₒ,yₒ)=(200,800) and moving in a direction indicated by the arrow with a velocity (vₓ,v_{y})=(\sqrt{2,−\sqrt{2}}). The measurement arc diagram 600 also includes a plurality of measurement arcs corresponding to 40-meter synthetic apertures located at angles of {π/6,4π/6, . . . ,16π/6}, which are steps of π/2 around a circular trajectory of 1000 meters radius. The 40-meter synthetic apertures are employed by a platform moving in a circular trajectory around a base station 610, which serves as the origin for the geo-location coordinates.

Movement of the MOI 605 relative to the platform produces an additional linear phase-shift, which if not accounted for, gives a biased LOP. The velocities vₓ and v_{y} are the velocity components of the MOI 605. Then the position of the MOI 605 can be expressed as the time-varying vector of equation (19) below.

$${\underline{x}}_{o} ( t ) = [ \begin{matrix}{x}_{o} + {v}_{x} t \\ {y}_{o} + {v}_{y} t \\ 0\end{matrix} ] . \qquad ( 19 )$$

The linear phase-term in the Taylor expansion of equation (10) is proportional to η(t₀)=r^{T}\dot{r}. When the MOI 605 is moving, an equation (20) may be obtained as shown below.

$$η ( {t}_{0} ) = {x}_{o} [ {α}_{p} {r}_{p} sin ( {α}_{p} {t}_{0} ) + {v}_{x} ] + {y}_{o} [ - {α}_{p} {r}_{p} cos ( {α}_{p} {t}_{0} ) + {v}_{y} ] + {v}_{x} {r}_{p} [ {α}_{p} {t}_{0} sin ( {α}_{p} {t}_{0} ) - cos ( {α}_{p} {t}_{0} ) ] + {v}_{y} {r}_{p} [ - {α}_{p} {t}_{0} cos ( {α}_{p} {t}_{0} ) - sin ( {α}_{p} {t}_{0} ) ] + ( {v}_{x}^{2} + {v}_{y}^{2} ) {t}_{0} . \qquad ( 20 )$$

Thus, the motion of the MOI 605 can induce an LOP that is in the wrong position. Four independent SAG measurements can theoretically give unique estimates for both the position (xₒ,yₒ) and the velocity (vₓ,v_{y}) of the MOI 605. Equation (20) may be particularly difficult to solve for all the variables simultaneously. However, a technique that uses more than four observations but is simple to implement will be employed.

If the velocities (vₓ,v_{y}) are known, equation (20) is linear in xₒ and yₒ Therefore, a method to estimate the velocities (vₓ,v_{y}) directly is beneficial. Because the platform is moving in a circle, points along the circle may be chosen to make the measurements. For example, measurements at time t₀ and t₀+π/αₚ are diametrically opposite one another. These two measurements may be added to obtain equation (21) below.

$$η ( {t}_{0} ) + η ( {t}_{0} + π / {α}_{p} ) = 2 ( {x}_{o} {v}_{x} + {y}_{o} {v}_{y} ) - {v}_{x} {r}_{p} π sin ( {α}_{p} {t}_{0} ) + {v}_{y} {r}_{p} π cos ( {α}_{p} {t}_{0} ) + ( {v}_{x}^{2} + {v}_{y}^{2} ) ( 2 {t}_{0} + π / {α}_{p} ) . \qquad ( 21 )$$

This approach may be repeated with two other diametrically opposite measurements at t₀+π/(2αₚ) and t₀+3π/(2αₚ) to obtain equation (22) below.

$$η ( {t}_{0} + π / ( 2 {α}_{p} ) ) + η ( {t}_{0} + 3 π / ( 2 {α}_{p} ) ) = 2 ( {x}_{o} {v}_{x} + {y}_{o} {v}_{y} ) - {v}_{x} {r}_{p} π cos ( {α}_{p} {t}_{0} ) - {v}_{y} {r}_{p} π sin ( {α}_{p} {t}_{0} ) + ( {v}_{x}^{2} + {v}_{y}^{2} ) ( 2 {t}_{0} + 2 π / {α}_{p} ) . \qquad ( 22 )$$

Then define γ(t₀) to be the difference of these two summations as shown in equation (23) below.

$$\begin{matrix}γ ( {t}_{0} ) = η ( {t}_{0} ) - η ( {t}_{0} + π / ( 2 {α}_{p} ) ) + η ( {t}_{0} + π / {α}_{p} ) \\ - η ( {t}_{0} + 3 π / 2 {α}_{p} ) ) \\ = {v}_{x} {r}_{p} π [ cos ( {α}_{p} {t}_{0} ) - sin ( {α}_{p} {t}_{0} ) ] + \\ {v}_{y} {r}_{p} π [ cos ( {α}_{p} {t}_{0} ) + sin ( {α}_{p} {t}_{0} ) ] - ( {v}_{x}^{2} + {v}_{y}^{2} ) π / {α}_{p} .\end{matrix} \qquad ( 23 )$$

The computation of γ(t₀) requires measurements at {t₀+lπ(2αₚ),l=0, . . . ,3}, which are spaced evenly around the circular trajectory of the platform.

Since equation (23) is valid for any t₀, the calculations are repeated for another starting point t₁, and the difference taken as shown in equation (24) below.

$$γ ( {t}_{0} ) - γ ( {t}_{1} ) = π {r}_{p} [ {v}_{x} ( cos ( {α}_{p} {t}_{0} ) - sin ( {α}_{p} {t}_{0} ) - cos ( {α}_{p} {t}_{1} ) + sin ( {α}_{p} {t}_{1} ) ) + {v}_{y} ( cos ( {α}_{p} {t}_{0} ) + sin ( {α}_{p} {t}_{0} ) - cos ( {α}_{p} {t}_{1} ) - sin ( {α}_{p} {t}_{1} ) ] , \qquad ( 24 )$$

which eliminates the quadratic terms in vₓ and v_{y} and leaves a linear equation. If t₁=t₀+π/(2αₚ), then β(t₀) may be defined as the difference as shown in equation (25) below.

β(t₀)=γ(t₀)−γ(t₀+π/(2αₚ))=2πrₚ[νₓ cos(αₚt₀)+ν_{y} sin(αₚt₀)], (25)

which is a particularly simple equation. Computing β(t₀) in equation (25) requires the five measurements {t₀+lπ/(2αₚ),l=0, . . . ,4} These five measurements are again spaced evenly around the circular trajectory of the platform, at intervals of π/2 starting at t₀ and ending at t₀+2π/αₚ. The equation (25) may be called a line-of-velocity (LOV).

Two LOV's of the form of equation (25) are all that is needed to solve for vₓ and v_{y}, since only a point where the lines cross needs to be found. To minimize the number of independent measurements needed, a second equation involving β(t₀+π/(2αₚ)) may be obtained, which is shown in equation (25a) below.

β(t₀+π/(2αₚ))=2πrₚ[−vₓ sin(αₚt₀)+v_{y} cos(αₚt₀)]. (25a)

A total of six measurements are then needed to compute both β(t₀) and β(t₀+π/(2αₚ)), from which vₓ and v_{y} can be computed directly. Note that once vₓ and v_{y} are known, these values may be used in equation (20) to compute η(t₀) which is linear in xₒ and yₒ thereby creating an LOP. Hence, solving for xₒ and yₒ becomes solving two simultaneous linear equations.

Turning now to FIG. 6B, illustrated is a diagram of uncompensated LOPs, generally designated 625, corresponding to the synthetic aperture measurements on the MOI 605 of FIG. 6A. These LOPs are uncompensated in the sense that they assume that the MOI 605 is stationary. This analysis provides insight into the errors that may occur if the motion of the MOI 605 is neglected. The calculated uncompensated LOPs are for the MOI 605 with velocity (vₓ,v_{y})=(\sqrt{2,−\sqrt{2}}) and a 0 dB post-despreading SINR.

The LOPs are taken from observations at angles {π/6,4π/6, . . . ,16π/6}, which are steps of π/2 around the circle of 1000 meters radius with 40-meter synthetic apertures. The calculated positions of the MOI 605 are indicated by their angles of observation corresponding to the LOP of the same designation. While the moving MOI 605 appears (approximately) somewhere on its corresponding LOP, the intersection points of the LOPs are essentially meaningless because they are uncompensated.

Turning now to FIG. 6C, illustrated is a diagram of calculated LOVs, generally designated 650, corresponding to the synthetic aperture measurements on the moving MOI 605 of FIG. 6A. The calculated LOVs are labeled in correspondence to the angles of observation as discussed with respect to FIG. 6A. It may be seen that the LOVs cross at approximately the correct velocity as indicated by the correct velocity 655.

Turning now to FIG. 6D, illustrated is a diagram of compensated LOPs, generally designated 675, corresponding to the synthetic aperture measurements on the moving MOI 605 of FIG. 6A. After the velocity is estimated as in FIG. 6C, the compensated LOPs may be computed using these estimates. In the absence of noise, the LOP's would all intersect at an MOI true position 680 of t=0(200,800). Instead, they all intersect within approximately 20 meters of the MOI true position 680.

Returning again to FIG. 1 and recalling the previous discussions, it was shown that appropriate accuracy is possible using a single antenna on a moving platform employing a synthetic aperture. Having more than one antenna on the platform simultaneously receiving the MOI signal may also be beneficial. Two possible such configurations include linear arrays arranged either axially (along the platform's fuselage), or transversally (along the wingspan) Since a synthetic array has already been created axially by the motion of the platform, additional antennas located axially may increase LOP estimation accuracy, but will not fundamentally change the way the LOP or the MOI's velocity is computed. On the other hand, antennas located transversally may help simplify some computations.

A simple case of two transversal antennas includes one on each wing of the platform. Since the airplane is traveling substantially in a circle, the antennas may be located at different radii rₚ and r′ₚ. It may be assumed that r′ₚ>rₚ and that a difference r′ₚ−rₚ may be approximately five to ten meters. Assume that two biased LOP'S are obtained independently from the measurements at rₚ and r′ₚ. Then equating equation (20) for the measurement at r′ₚ becomes equation (26) below:

$${η}^{′} ( {t}_{0} ) = {x}_{o} [ {α}_{p} {r}_{p}^{′} sin ( {α}_{p} {t}_{0} ) + {v}_{x} ] + {y}_{o} [ - {α}_{p} {r}_{p}^{′} cos ( {α}_{p} {t}_{0} ) + {v}_{y} ] + {v}_{x} {r}_{p}^{′} [ {α}_{p} {t}_{0} sin ( {α}_{p} {t}_{0} ) - cos ( {α}_{p} {t}_{0} ) ] + {v}_{y} {r}_{p}^{′} [ - {α}_{p} {t}_{0} cos ( {α}_{p} {t}_{0} ) - sin ( {α}_{p} {t}_{0} ) ] + ( {v}_{x}^{2} + {v}_{y}^{2} ) {t}_{0} . \qquad ( 26 )$$

Forming the difference between η′(t₀) and η(t₀) yields equation (27):

$$\frac{{η}^{′} ( {t}_{0} ) - η ( {t}_{0} )}{{r}_{p}^{′} - {r}_{p}} = {x}_{o} {α}_{p} sin ( {α}_{p} {t}_{0} ) - {y}_{o} {α}_{p} cos ( {α}_{p} {t}_{0} ) + {v}_{x} [ {α}_{p} {t}_{0} sin ( {α}_{p} {t}_{0} ) - cos ( {α}_{p} {t}_{0} ) ] + {v}_{y} [ - {α}_{p} {t}_{0} cos ( {α}_{p} {t}_{0} ) - sin ( {α}_{p} {t}_{0} ) ] . \qquad ( 27 )$$

Equation (27) is compelling because it is linear in the position (xₒ,yₒ) and the velocity (vₓ,v_{y}). Therefore, in principle, only four such difference-measurements are needed to be able to solve the linear system of equations in four unknowns. However, noise sensitivity needs to be analyzed for this system.

A sensitivity analysis suggests that this system is not as robust as the original equation (20). For example, if the MOI is stationary, then equation (20) yields:

η(t₀)=rₚαₚ[xₒ sin(αₚt₀)−yₒ cos(αₚt₀)], (??)

while equation (27) yields:

η′(t₀)−η(t₀)=(r′ₚ−rₚ)αₚ[xₒ sin(αₚt₀)−yₒ cos(αₚt₀)]. (??)

Suppose that from noisy observations the estimates \hat{η}(t₀)=η(t₀)+nₜ and \hat{η}′(t₀)=η′(t₀)+n′ₜ are formed such that the estimation errors ηₜ and η′ₜ are independent and each have equal variance. Then the LOP formed from η′(t₀)-Q(t₀) has a standard deviation \sqrt{2}rₚ/(r′ₚ−rₚ) greater than the LOP formed from just η(t₀). With rₚ=1000 meters, and r′ₚ−rₚ=7.4 meters, this factor is approximately 191. Whether this reduction in accuracy is acceptable depends on the signal-to-noise ratios (SNRs) that are likely to be encountered on the platform.

Turning now to FIG. 7, illustrated is a flow diagram of an embodiment of a method for locating a mobile transmitter, generally designated 700, carried out in accordance with the principles of the present invention. The method 700 starts in a step 705 and may be used, for example, to provide a location of a cellular phone operating within a wireless cell that employs a cellular base station. The cellular phone may be either stationary or moving, and employing the method 700 can establish its location to within about 20 meters, in one embodiment.

Then, in a step 710, a wireless signal from a mobile transmitter is received at a sequence of locations of a receiver. In one embodiment, the receiver is located within a moving aircraft that provides this sequence of locations. Reception of the wireless signal from the mobile transmitter employs a directional reception afforded by a directional antenna mounted on the aircraft. In one embodiment, the directional reception employs orthogonal reception components, which are derived from antenna elements that employ half-wavelength spacing of the wireless signal.

In one embodiment, the directional antenna array maintains one antenna element that is perpendicular to the aircraft's orbit and additionally maintains another antenna element that is directed along a radius of the orbit. In another embodiment, the directional antenna array employs one antenna element that is tangent to the orbit and another pair of antenna elements that are radial or transverse to the orbit.

One or more phase-dependent characteristics of the wireless signal are determined in a step 715, wherein the one or more characteristics depend on relative locations of the receiver and the mobile transmitter. Generally, determining one or more of these phase-dependent characteristics employs location data corresponding to multiple measurement sites of the receiver. In one embodiment, the multiple measurement sites correspond to the receiver maintaining a substantially circular trajectory around the mobile transmitter. Additionally, the multiple measurement sites may correspond to the receiver maintaining a substantially constant altitude over the mobile transmitter. Also, the multiple measurement sites may correspond to the receiver maintaining a substantially constant speed.

In a step 720, a geo-location of the mobile transmitter is found from the one or more phase-dependent characteristics that are determined in the step 715. Finding this geo-location employs a synthetic aperture geo-location technique using the determined phase-dependent characteristics. Generally, the synthetic aperture geo-location technique employs regularly-spaced measurement intervals, and in one embodiment, the regularly-spaced measurement intervals correspond to at least four locations on a substantially circular trajectory of the receiver. Additionally, these at least four locations may occur over at least one half the length of the substantially circular trajectory. Alternatively, the regularly-spaced measurement intervals along the circular trajectory may correspond to angular increments of about ninety degrees.

The method 700 uses the synthetic aperture geo-location technique employing multiple receptions of the wireless signal to reduce an error in the geo-location of the mobile transmitter below a predetermined value. Various examples and aspects of this synthetic aperture geo-location technique were discussed with respect to the earlier FIGS. 1 through 6D. The method 700 ends in a step 725.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

Although the present invention has been described in detail, those skilled in the art should understand that they can make various changes, substitutions and alterations herein without departing from the spirit and scope of the invention in its broadest form.

What is claimed is:

1. An apparatus, comprising:
a module configured to determine a location of a mobile device based on phase-sensitive measurements of wireless signals transmitted by the mobile device; and
wherein the module is configured to determine the location based on the phase-sensitive measurements of the wireless signals made at multiple measurement sites.

2. The apparatus of claim 1, wherein the module includes an interface configured to provide location data corresponding to multiple measurement sites created by an orbiting aircraft.

3. The apparatus of claim 2, wherein the location data provided by the interface corresponds to the module maintaining a substantially circular trajectory around the mobile device.

4. The apparatus of claim 2, wherein the location data provided by the interface corresponds to the module maintaining a substantially constant altitude over the mobile device.

5. The apparatus of claim 2, wherein the location data provided by the interface corresponds to maintaining a substantially constant speed of the module.

6. The apparatus of claim 1, wherein the module includes a directional antenna configured to provide a data signal proportional to the wireless signals transmitted by the mobile device.

7. The apparatus of claim 6 wherein the directional antenna employs orthogonal antenna elements oriented for reception of the wireless signals.

8. The apparatus of claim 7 wherein the orthogonal antenna elements employ half-wavelength spacing.

9. The apparatus of claim 1 wherein the module is configured to use a synthetic aperture geo-location technique employing the phase-sensitive measurements of the wireless signals to reduce an error in a geo-location of the mobile device below a predetermined value.

10. The apparatus of claim 9 wherein the module is configured to employ multiple measurement sites corresponding to regularly-spaced measurement intervals.

11. A method, comprising:
receiving a wireless signal from a mobile transmitter at a sequence of locations of a receiver;
determining one or more phase-dependent characteristics of the wireless signal, the one or more characteristics depending on relative locations of the receiver and the mobile transmitter; and
finding a geo-location of the mobile transmitter from the determined one or more phase-dependent characteristics.

12. The method of claim 11, wherein receiving the wireless signal employs a directional reception of the wireless signal.

13. The method of claim 12 wherein the directional reception employs orthogonal reception components.

14. The method of claim 13, wherein the orthogonal reception components are derived from antenna elements that employ half-wavelength spacing.

15. The method of claim 11, wherein determining one or more phase-dependent characteristics employs location data corresponding to multiple measurement sites of the receiver.

16. The method of claim 15, wherein the multiple measurement sites correspond to the receiver maintaining a substantially circular trajectory around the mobile transmitter.

17. The method of claim 15, wherein the multiple measurement sites correspond to the receiver maintaining a substantially constant altitude over the mobile transmitter.

18. The method of claim 15, wherein the multiple measurement sites correspond to the receiver maintaining a substantially constant speed.

19. The method of claim 11 wherein finding the geo-location of the mobile transmitter employs a synthetic aperture geo-location technique using the one or more phase-dependent characteristics.

20. The method of claim 19 wherein the synthetic aperture geo-location technique employs regularly-spaced measurement intervals.

21. The method of claim 20, wherein the regularly-spaced measurement intervals correspond to at least four locations on a substantially circular trajectory of the receiver.

22. The method of claim 21, wherein the at least four locations occur over at least one half the length of the substantially circular trajectory.
